(19) United States
(12) Patent Application Publication
(10) Pub. No.: US 2014/0126787 A1
(43) Pub. Date: May 8, 2014

(54) DEVICE AND METHOD FOR GENERATING MELANOMA RISK ASSESSMENTS

(71) Applicant: LASAROW HEALTHCARE TECHNOLOGIES LIMITED, London (GB)

(72) Inventors: Kristi Zuhlke Kimball, Naperville, IL (US); Jason Boggess, Cambridge, MA (US)

(73) Assignee: Lasarow Healthcare Technologies Limited, London (GB)

(21) Appl. No.: 13/672,306

(22) Filed: Nov. 8, 2012

(51) Int. Cl. G06K 9/00

(52) U.S. Cl. CPC G06K 9/00362
USPC 382/128

(57) ABSTRACT

According to one embodiment of this disclosure, a method is provided that includes obtaining mole image information; detecting a particular mole from among the one or more moles based on the mole image information to provide particular mole image information; obtaining mole diameter information; analyzing the particular mole image information to determine (i) whether the particular mole is substantially asymmetrical, (ii) whether a border of the particular mole is substantially circular, and (iii) whether the particular mole comprises one or more substantially different colors to provide asymmetry, border, and color (ABC) analysis data; analyzing the mole diameter information to determine whether an estimated diameter of the particular mole exceeds a predetermined threshold to provide diameter (D) analysis data; and generating a plurality of melanoma risk assessments for the particular mole based on at least the ABC analysis data and the D analysis data.

### BACKGROUND

Melanoma is the most dangerous type of skin cancer and the leading cause of death from skin disease. In fact, it is estimated that seventy-five percent (75%) of deaths related to skin cancer are attributed to melanoma. Unfortunately, melanoma is also a highly prevalent type of skin cancer. For instance, worldwide, nearly one-hundred and sixty-thousand (160,000) new cases of melanoma are diagnosed each year. Further still, the proportion of people afflicted by melanoma has steadily risen over the past thirty years. Despite the danger and prevalence of melanoma, it is a highly treatable condition if detected early. For example, the five-year survival rate for people whose melanoma is detected and treated before it spreads to the lymph nodes is more than ninety-percent (90%).

While melanoma may occur in many parts of the body, such as the eye, oral cavity, or bowel, it predominantly occurs on the skin. In this regard, melanoma is one of the few types of cancer that can be visually detected in a non-evasive manner. Indeed, presently, there is not a blood test for detecting melanoma. In order to assess whether a particular skin growth (e.g., a mole) may be melanoma, dermatologists typically employ what is called “ABCDE” analysis. “ABCDE” is a mnemonic/acronym that stands for: Asymmetry, Border, Color, Diameter, and Evolution. The ABCDE technique calls for the analysis of a skin growth with respect to each of the ABCDE factors.

The “A” factor asks whether the skin growth is asymmetrical about its x and/or y axes. Asymmetry of a skin growth may indicate that one area of the growth is expanding at a greater rate than another area of the same growth, which is a symptom of melanoma. The “B” factor asks whether the border of the skin growth is uneven, ragged, or notched. Uneven, ragged, or notched borders are also indicative of melanoma. The “C” factor asks whether the skin growth is consistent in its color. Growths that exhibit different shades of, for example, brown, black, and/or tan are indicative of melanoma. The “D” factor asks whether the diameter of the skin growth is greater than six millimeters (6 mm). Growths exhibiting a diameter larger than 6 mm are more likely to be melanoma than growths under 6 mm in diameter. Finally, the “E” factor asks whether the skin growth has evolved, or enlarged, over time. Growths that evolve over time are more likely to be melanoma than static growths.

Conventional techniques exist that are aimed at automating the ABCDE analysis through digital image processing. For instance, one known technique requires transmitting a digital image of a skin growth from the device that captured the image to a remote server for analysis. In this technique, the image is compared against one or more other images stored on the remote server in order to assess whether the skin growth is likely to be melanoma. One drawback of this technique is that it may take a considerable amount of time to transmit the image data from the device to the remote sever, process the image data remotely, and then transmit melanoma diagnosis results back to the device that captured the image initially. Moreover, this technique requires network access in order to supply any melanoma risk assessment. Further still, a melanoma detecting approach that compares the image of a growth for which the melanoma status is unknown against one or more previously stored images of melanoma/non-melanoma growths is susceptible to inaccurate melanoma diagnoses because of, for example, the disparity between the image of the mole under analysis and the previously stored images (e.g., in terms of picture resolution, lighting, perspective, contrast, etc.).

Another drawback associated with traditional ABCDE image processing techniques concerns the quality of the image that is captured for analysis. For example, many conventional techniques rely heavily on a user to capture a high-quality image of the growth for analysis thereby introducing human-error into the process. For instance, these conventional techniques rely on the user exercising their best judgment when centering the growth within the image, ensuring that the image is taken from a proper distance, etc. This issue is compounded when the user has multiple growths within a small area. In this situation, it is often difficult for an automated image processing system to ascertain which particular growth should be analyzed for melanoma.

Yet another shortcoming of conventional ABCDE image processing techniques is that they rarely take advantage of other criteria, beyond the ABCDE factors, that may influence the likelihood of a particular growth being melanoma.

Accordingly, a new device and technique is needed in order to address one or more of the foregoing limitations of existing technology.

### SUMMARY

The instant disclosure describes devices and methods for generating a melanoma risk assessment for one or more skin growths. To this end, in one example, a method is provided. The method includes obtaining mole image information. The mole image information includes one or more digital images of one or more moles including a particular mole for which melanoma risk assessment is sought. The particular mole may be detected from among the one or more moles based on the mole image information to provide particular mole image information. Mole diameter information may also be obtained. Mole diameter information includes information describing an estimated diameter of the particular mole for which melanoma risk assessment is sought. The particular mole image information may be analyzed to make a number of determinations. Specifically, the particular mole image information may be analyzed to determine (i) whether the particular mole is substantially asymmetrical, (ii) whether a border of the particular mole is substantially circular, and (iii) whether the particular mole comprises one or more substantially different colors to provide asymmetry, border, and color (ABC) analysis data. The mole diameter information may be analyzed to determine whether the estimated diameter of the particular mole exceeds a predetermined threshold to provide diameter (D) analysis data. A plurality of melanoma risk assessments for the particular mole may be generated based on at least the ABC analysis data and the D analysis data.

In another example, detecting the particular mole from among the one or more moles includes generating a first graphical user interface (GUI). The first GUI may include an image capture field and a mole selection marker. The mole selection marker includes display data identifying the particular mole for which analysis is sought. In yet another example, the method includes generating a second GUI that includes an avatar of a human body. In this example, the method may also include obtaining mole location information. Mole location information includes information identifying a location on the avatar corresponding to the particular mole for which analysis is sought. In still another example of this method, the method may additionally include analyzing the mole location information to determine if the particular mole resides in a high-melanoma risk area to provide location (L) analysis data. In this example, generating the plurality of melanoma risk assessments for the particular mole may also be based on the L analysis data.

In another example of the method, obtaining the mole diameter information includes generating a third GUI. The third GUI may include a ruler and a mole diameter input field that is configured to obtain the mole diameter information. In yet another example of the method, generating the plurality of melanoma risk assessments for the particular mole may include generating a separate melanoma risk assessment with regard to each of the ABCDE factors “asymmetry,” “border,” “color,” and “diameter.” In still another example, the method may further include generating a cumulative melanoma risk assessment for the particular mole. The cumulative melanoma risk assessment may be based on one or more of the plurality of melanoma risk assessments.

In one example, the method includes providing an evolution risk assessment with regard to a particular mole. In this example, the method includes obtaining new mole image information. The new mole image information is obtained after the mole image information and includes one or more new digital images of at least the particular mole for which melanoma risk assessment is sought. The particular mole may be detected based on the new mole image information to provide new particular mole image information. New mole diameter information may also be obtained. The new mole diameter information may be obtained after the mole diameter information and describes a new estimated diameter of the particular mole. The new particular mole image information may be analyzed to determine (i) whether the particular mole is substantially asymmetrical, (ii) whether the border of the particular mole is substantially circular, and (iii) whether the particular mole comprises one or more substantially different colors to provide new asymmetry, border, and color (ABC) analysis data. The new mole diameter information may also be analyzed to determine whether the new estimated diameter of the particular mole exceeds the predetermined threshold to provide new mole diameter (D) analysis data. A plurality of new melanoma risk assessments may be generated for the particular mole based on at least the new ABC analysis data and the new D analysis data. Each of the respective new melanoma risk assessments may be compared with respective corresponding melanoma risk assessments to provide an evolution risk assessment.

According to another embodiment, a computing device is provided. The computing device includes, at least, a mole detector, a mole analyzer, and a melanoma risk assessment generator. The mole detector is configured to obtain the mole image information and detect the particular mole for which melanoma risk assessment is sought from among the one or more moles depicted in the mole image information—based on the mole image information—to provide particular mole image information. The mole analyzer is operatively connected to the mole detector and is configured to obtain mole diameter information, which includes information describing an estimated diameter of the particular mole. The mole analyzer is further configured to analyze the particular mole image information to determine (i) whether the particular mole is substantially asymmetrical, (ii) whether a border of the particular mole is substantially circular, and (iii) whether the particular mole comprises one or more substantially different colors to provide asymmetry, border, and color (ABC) analysis data. The mole analyzer is also configured to analyze the mole diameter information to determine whether the estimated diameter of the particular mole exceeds a predetermined threshold to provide diameter (D) analysis data. The melanoma risk assessment generator is operatively connected to the mole analyzer and is configured to generate a plurality of melanoma risk assessments for the particular mole based on at least the ABC analysis data and the D analysis data.

In one example, the computing device also includes a graphical user interface (GUI) generator. The GUI generator is configured to generate at least three different GUIs. The first GUI may include an image capture field and a mole selection marker. The mole selection marker includes display data identifying the particular mole for which analysis is sought. The second GUI may include an avatar of the human body. The third GUI may include a ruler and a mole diameter input field, where the mole diameter input field is configured to obtain the mole diameter information.

In another example, the mole analyzer may be further configured to obtain mole location information, which includes information identifying a location on the avatar corresponding to the particular mole for which analysis is sought. In this example, the mole analyzer may also be configured to analyze the mole location information to determine if the particular mole resides in a high-melanoma risk area to provide location (L) analysis data. In one example, the melanoma risk assessment generator is further configured to generate the plurality of melanoma risk assessments for the particular mole also based on the L analysis data.

In still another example, the melanoma risk assessment generator is further configured to generate a separate melanoma risk assessment for the particular mole with regard to asymmetry, border, color, and diameter. In yet another example, the melanoma risk assessment generator is further configured to generate a cumulative melanoma risk assessment for the particular mole. In this example the cumulative melanoma risk assessment may be based on one or more of the plurality of melanoma risk assessments.

In one example, the computing device is configured to provide an evolution risk assessment with regard to the particular mole. In this example, the mole detector may be further configured to obtain new mole image information, which includes one or more new digital images of at least the particular mole for which melanoma risk assessment is sought and detect the particular mole based on the mole image information to provide new particular mole image information. In this example, the mole analyzer may be further configured to obtain new mole diameter information, which includes information describing a new estimated diameter of the particular mole. The mole analyzer may also determine (i) whether the particular mole is substantially asymmetrical, (ii) whether the border of the particular mole is substantially circular, and (iii) whether the particular mole comprises one or more substantially different colors to provide new asymmetry, border, and color (ABC) analysis data. The mole analyzer may be further configured to analyze the new mole diameter information to determine whether the new estimated diameter of the particular mole exceeds the predetermined threshold to provide new diameter (D) analysis data. Continuing with this example, the melanoma risk assessment generator may be further configured to generate a plurality of new melanoma risk assessments for the particular mole based on at least the new ABC analysis data and the new D analysis data and compare each respective new melanoma risk assessment of the plurality of new melanoma risk assessments with a corresponding melanoma risk assessment of the plurality of melanoma risk assessments to provide an evolution risk assessment.

According to yet another embodiment, a computer program product embodied in a non-transitory computer-readable medium having an algorithm adapted to effectuate a method is provided. According to the method, a particular mole from among one or more moles may be detected based on mole image information to provide particular mole image information. The particular mole image information may include one or more digital images of one or more moles including the particular mole for which melanoma risk assessment is sought. The particular mole image information may be analyzed to determine (i) whether the particular mole is substantially asymmetrical, (ii) whether a border of the particular mole is substantially circular, and (iii) whether the particular mole comprises one or more substantially different colors to provide asymmetry, border, and color (ABC) analysis data. Mole diameter information may also be analyzed to determine whether an estimated diameter of the particular mole exceeds a predetermined threshold to provide diameter (D) information. Mole diameter information may include information describing an estimated diameter of the particular mole. A plurality of melanoma risk assessments may also be generated for the particular mole based on at least the ABC analysis data and the D analysis data.

These and other objects, features, and advantages of the foregoing method, computing device, and computer program product will become more apparent upon reading the following specification in conjunction with the accompanying drawing figures.

### BRIEF DESCRIPTION OF THE FIGURES

Reference will now be made to the accompanying figures and flow diagrams, which are not necessarily drawn to scale, and wherein:

FIG. 1 is a block diagram illustrating one example of a computing device suitable for use in generating a melanoma risk assessment in accordance with the disclosed technology.

FIG. 2 is a block diagram illustrating another example of a computing device suitable for use in generating a melanoma risk assessment in accordance with the disclosed technology.

FIG. 3 is a diagram illustrating one example of graphical user interface suitable for use in generating a melanoma risk assessment in accordance with the disclosed technology.

FIG. 4 is a diagram illustrating another example of graphical user interface suitable for use in generating a melanoma risk assessment in accordance with the disclosed technology.

FIG. 5 is a diagram illustrating yet another example of graphical user interface suitable for use in generating a melanoma risk assessment in accordance with the disclosed technology.

FIG. 6 is a diagram illustrating still another example of graphical user interface suitable for use in generating a melanoma risk assessment in accordance with the disclosed technology.

FIG. 7 is a flow diagram illustrating a method for generating one or more melanoma risk assessments in accordance with the disclosed technology.

FIG. 8 is a flow diagram illustrating a method for generating a mole evolution risk assessment in accordance with the disclosed technology

### DETAILED DESCRIPTION

To facilitate an understanding of the principals and features of the disclosed technology, illustrative embodiments are explained below. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

Various embodiments of the disclosed technology provide methods, devices, and computer program products for generating melanoma risk assessments. In one example embodiment, a method for generating melanoma risk assessments is provided. The method may include obtaining, by a processing device, mole image information, wherein the mole image information comprises one or more digital images of one or more moles including a particular mole for which melanoma risk assessment is sought. The particular mole may be detected from among the one or more moles based on the mole image information to provide particular mole image information. The processing device may further obtain mole diameter information, wherein the mole diameter information includes information describing an estimated diameter of the particular mole. The particular mole image information may be analyzed by the processing device to determine (i) whether the particular mole is substantially asymmetrical, (ii) whether a border of the particular mole is substantially circular, and (iii) whether the particular mole comprises one or more substantially different colors to provide asymmetry, border, and color (ABC) analysis data. The mole diameter information may also be analyzed by the processing device to determine whether the estimated diameter of the particular mole exceeds a predetermined threshold to provide diameter (D) analysis data. The processing device may also generate a plurality of melanoma risk assessments for the particular mole based on at least the ABC analysis data and the D analysis data.

In another example embodiment, a computer program product embodied in a non-transitory computer-readable medium comprising an algorithm adapted to effectuate a method, such as the foregoing method, is provided.

Referring now to the figures, in which like reference numerals represent like parts, various embodiments of the computing device and methods will be disclosed in detail. FIG. 1 is a block diagram illustrating one example of a computing device 100 suitable for use in generating a melanoma risk assessments. The computing device 100 may be, for example, a cellular phone, a “smart” phone, a personal digital assistant (PDA), a tablet, a laptop or desktop computer, or any other suitable communication device capable of performing the processing described herein.

In the illustrated example, the computing device 100 includes a controller 102, a transceiver 108, a user input/output interface 110, and peripheral devices 112. The controller 102 includes one or more processors 104 and memory 106. In an embodiment, the one or more processors 102 may include one or more devices such as microprocessors, microcontrollers, digital signal processors, or combinations thereof, capable of executing stored instructions and operating upon stored data that is stored in, for example, the memory 106. The memory 106 may include one or more devices such as volatile or nonvolatile memory including, but not limited to, random access memory (RAM) or read only memory (ROM). Further still, the memory 106 may be embodied in a variety of forms, such as a solid state drive, hard drive, optical disk drive, floppy disk drive, etc. Processor and memory arrangements of the types illustrated in FIG. 1 are well known to those having ordinary skill in the art. In one embodiment, the processing techniques described herein are implemented as a combination of executable instructions and data within the memory 106 used to control operation of, and operated upon by, the one or more processors 104.

The user input/output 110 may include any suitable components for receiving input from, and/or communicating output to, a user. For example, the user input components could include a keypad, a touch screen, a mouse, a microphone and suitable voice recognition application, etc. The user output components may include, for example, speaker(s), light(s) (e.g., one or more LED lights), buzzer(s) (e.g., one or more components capable of vibrating to alert the user, for example, of an incoming text message), etc. Other suitable input/output components will be discussed below with regard to peripheral devices 112. The transceiver 108 may comprise one or more suitable transceivers capable of transmitting and receiving information as known in the art. For example, the transceiver 108 may transmit and receive information using wireless communication resources implementing any of a variety of communication protocols, such as TDM (time-division-multiplexed) slots, carrier frequencies, a pair of carrier frequencies, or any other radio frequency (RF) transmission media. Further still, although the transceiver 108 is illustrated in FIG. 1 as being wireless, those having ordinary skill in the art will appreciate that the transceiver 108 may be additionally/alternatively capable of supporting communication using wired communication resources.

The peripheral devices 112 are any devices that are typically external to the computing device 100 that may nevertheless interact with the electronic device 100, non-limiting examples of which include a camera 114 and a display 116. While the peripheral devices 112 are typically external to the computing device 100, they may instead be incorporated into the computing device 100 as part of, for example, the user input/output 110. The camera 114 may be any suitable camera capable of capturing still image and/or video data using techniques known in the art. In one example, the camera 114 may include a digital camera configured to capture an image and/or video. The captured image/video may be stored locally, for example, in memory 106. The display 116 may include any conventional integrated or external display mechanism such as a touch screen, a LED display, a cathode ray tube (CRT) display, a plasma display, a LCD display, or any other display mechanism known to those having ordinary skill in the art. In an embodiment, the display 116, in conjunction with suitable stored instructions (e.g., suitable stored instructions stored in memory 106), may be used to implement one or more graphical user interfaces (GUIs), such as graphical user interface 118. Implementation of a graphical user interface in this manner is well known to those having ordinary skill in the art.

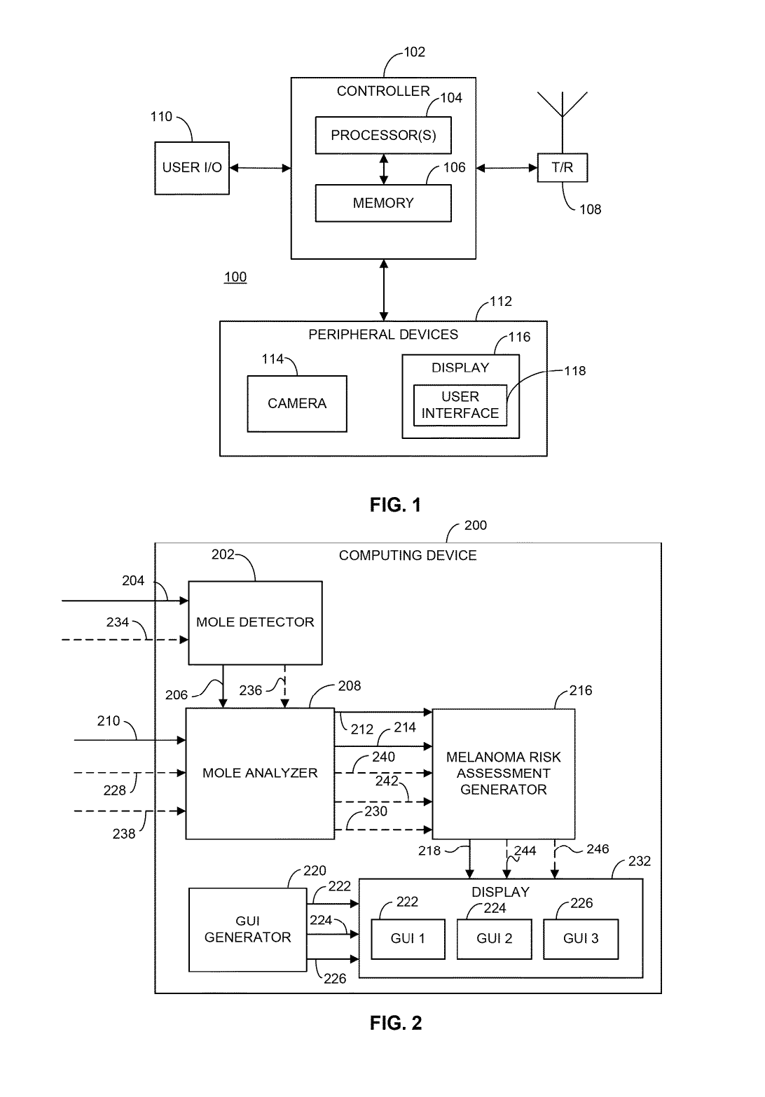

FIG. 2 is a block diagram illustrating another example of a computing device 200 for implementing the teachings of the disclosed technology. While the computing device 200 is discussed generically as to its functionality, it is noted that the computing device 200 may be implemented physically as the computing device 100 previously discussed. The computing device 200 includes a mole detector 202, a mole analyzer 208, a melanoma risk assessment generator 216, a GUI generator 220, and (optionally) a display 232 capable of displaying one or more GUIs, such as GUIs 222, 224, 226. In one example, the components 202, 208, 216, and 220 may be implemented as software modules that may be executed, for example, by one or more processors, such as the one or more processors 104 discussed above with regard to FIG. 1. However, those having ordinary skill in the art will recognize that the components 202, 208, 216, and 220 may equally be implemented using firmware and/or hardware devices such as application specific integrated circuits (ASICs), programmable logic arrays, state machines, etc. The GUIs 222, 224, 226 may be implemented in line with the discussion concerning the GUI 118 discussed above with regard to FIG. 1.

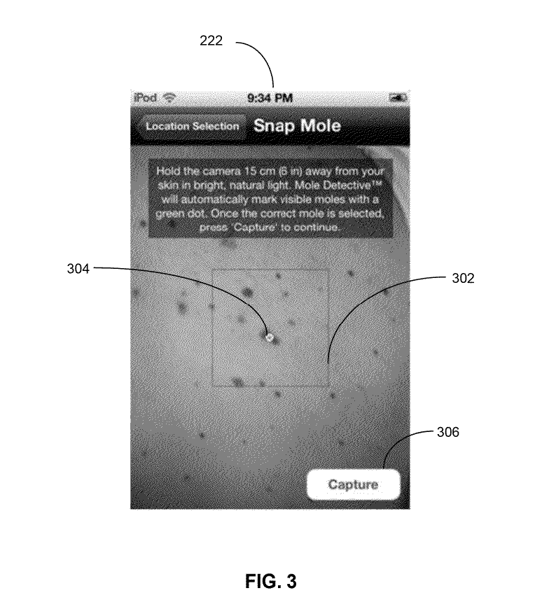

In operation, the mole detector 202 is configured to obtain mole image information 204. Mole image information 204 includes one or more digital images of one or more moles including a particular mole for which melanoma risk assessment is sought. The mole detector 202 may obtain the mole image information 204 directly from a device used to capture the mole image information 204 (e.g., the camera 114) or from storage (e.g., the memory 106). As used herein, “obtaining” may include fetching the mole image information 204 (e.g., from memory 106) or receiving pushed mole image information 204 from another source. Moreover, the mole image information 204 may be obtained from a source that is local to the computing device 200 (e.g., the camera 114 or memory 106) or from a remote source (e.g., a remotely located server computer or the like). Regardless, the mole detector 202 is further configured to detect the particular mole from among the one or more moles present in the mole image information in order to provide particular mole image information 206. The detecting functionality of the mole detector 202 is described in additional detail with regard to FIG. 3 below.

The computing device 200 also includes the mole analyzer 208, which is operatively connected to the mole detector 202. The mole analyzer 208 is configured to analyze the particular mole image information 206 generated by the mole detector 202 in order to make a number of determinations. Specifically, the mole analyzer 208 is configured to determine (i) whether the particular mole is substantially asymmetrical, (ii) whether a border of the particular mole is substantially circular, and (iii) whether the particular mole comprises one or more substantially different colors to provide asymmetry, border, and color (ABC) analysis data 212. Details surrounding how the mole analyzer 208 makes asymmetry, border, and color determinations are provided below with regard to the discussion of FIG. 3

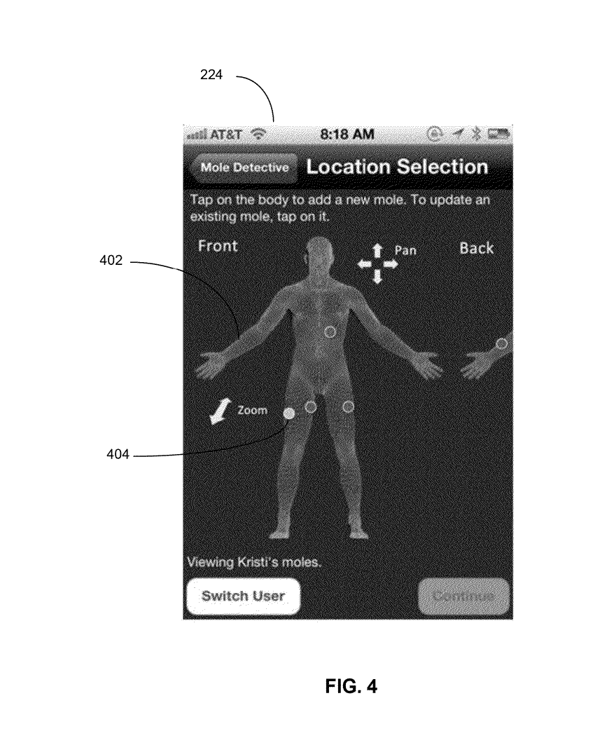

The mole analyzer 208 is also configured to obtain mole diameter information 210. The mole diameter information 210 includes information describing an estimated diameter of the particular mole for which melanoma risk assessment is sought. The means by which the mole diameter information 210 may be obtained will be discussed in additional detail with regard to FIG. 4 below. Once the mole diameter information 210 is obtained, the mole analyzer 208 may analyze the mole diameter information 210 to determine whether the estimated diameter of the particular mole exceeds a predetermined threshold. For example, in one embodiment, the mole analyzer 208 is configured to determine whether the estimated diameter of the particular mole is greater than six millimeters (6 mm). Melanoma research indicates that moles having diameters greater than 6 mm are more likely to be melanomas than moles having diameters less than 6 mm. Following the analysis of the mole diameter information 210, the mole analyzer 208 is configured to provide diameter (D) analysis data 214 to, for example, a melanoma risk assessment generator, such as the melanoma risk assessment generator 216 discussed below.

The melanoma risk assessment generator 216 is configured to obtain (i.e., fetch or receive) the ABC analysis data 212 and the D analysis data 214 from the mole analyzer 208 for further processing. Specifically, the melanoma risk assessment generator 216 is configured to generate a plurality of melanoma risk assessments 218 for the particular mole based on at least the ABC analysis data 212 and the D analysis data 214. In one example, generating the plurality of melanoma risk assessments 218 includes generating a separate melanoma risk assessment for each of the ABCD melanoma risk factors. That is to say, in this example, the melanoma risk assessment generator 216 is configured to generate a melanoma risk assessment for the particular mole specific to the factor “asymmetry,” a melanoma risk assessment for the particular mole specific to the factor “border,” a melanoma risk assessment for the particular mole specific to the factor “color,” a melanoma risk assessment for the particular mole specific to the factor “diameter,” and, optionally, a melanoma risk assessment for the particular mole specific to the factor “evolution.”

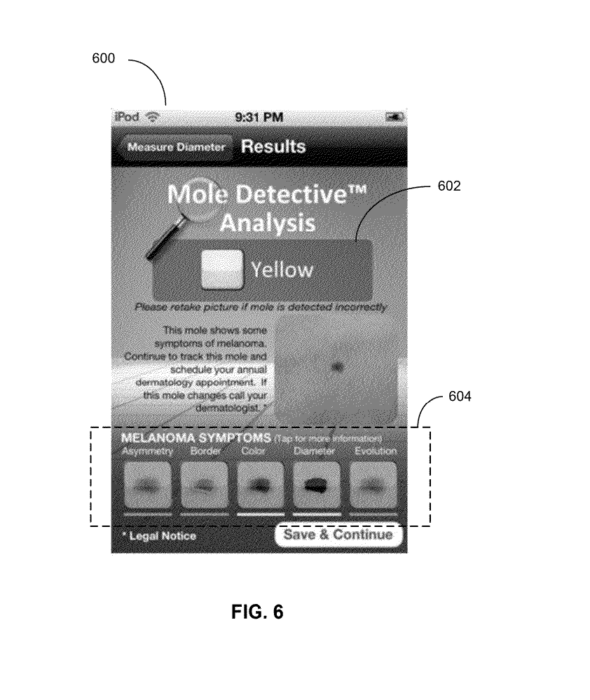

The plurality of melanoma risk assessments may be conveyed to a user as display data via a graphical user interface (e.g., via one or more GUIs on display 232), as discussed in greater detail with regard to FIG. 6 below. Furthermore, in one example, the melanoma risk assessment generator 216 is configured to generate a cumulative melanoma risk assessment for the particular mole (e.g., as one of the plurality of melanoma risk assessments 218). The cumulative melanoma risk assessment may broadly describe the melanoma-risk associated with the particular mole under analysis based on, for example, each of the discrete melanoma risk assessments generated for each of the ABCDE factors. For instance, if each of the melanoma risk assessments associated with each of the ABCDE factors for a particular mole indicate that the mole is unlikely to be melanoma, then it could be expected that the cumulative melanoma risk assessment would also indicate that the mole is unlikely to be melanoma. Conversely, if one or more of the melanoma risk assessments associated with each of the ABCDE factors for the particular mole indicate that the mole is likely to be melanoma, then it could be expected that the cumulative melanoma risk assessment would indicate that the mole is likely to be melanoma. This feature of the disclosed technology is also discussed in additional detail with regard to FIG. 6 below.

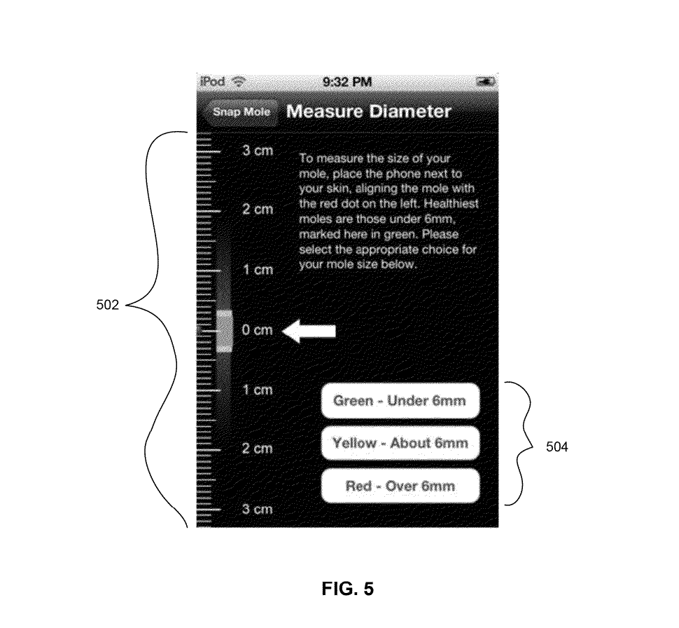

In one example, the computing device 200 also includes a GUI generator 220 configured to generate one or more GUIs, such as GUIs 222, 224, 226, etc. For example, the GUI generator 220 is configured to generate a first GUI 222 comprising an image capture field and a mole selection marker. The mole selection marker includes display data identifying the particular mole for which analysis is sought. An example of the first GUI 222 is illustrated with regard to FIG. 3 and discussed in additional detail below. The GUI generator 220 is also configured to generate a second GUI 224 that includes display data including an avatar of the human body. An example of the second GUI 224 is illustrated with regard to FIG. 4 and discussed in additional detail below. Finally, the GUI generator 220 is configured to generate a third GUI 226 that includes display data including a ruler and a mole diameter input field. The mole diameter input field may be configured to obtain the mole diameter information 210 discussed above. An example of the third GUI 226 is illustrated with regard to FIG. 5 and discussed in additional detail below.

In one exemplary embodiment, the mole analyzer 208 of the computing device 200 is further configured to obtain mole location information 228. The mole location information 228 includes information identifying a location on the avatar generated as part of the second GUI 224 discussed above. In this manner, a user can interact with the avatar portion of the second GUI 224 in order provide an indication of where on their body the particular mole that they want analyzed resides. This functionality is described in additional detail with regard to FIG. 4 below. Nonetheless, after the mole location information 228 is obtained, the mole analyzer 208 is configured to analyze the mole location information 228 to determine if the particular mole resides in a high-melanoma risk area to provide (L) analysis data 230. This analysis is driven by medical research indicating that moles located on certain parts of the human body are more likely to be melanoma than moles located on other parts of the human body.

For example, regardless of gender, melanoma is most likely to develop on areas of the body that are exposed to a high concentration of sunlight. Accordingly, in one example embodiment, the L analysis data 230 may indicate a heightened likelihood of melanoma where a user identifies a particular mole as residing on a body area that is regularly exposed to sun (e.g., the neck) using the second GUI 224. Alternatively or additionally, the L analysis data 230 may indicate a heightened likelihood of melanoma where a user identifies the particular mole for which analysis is being sought as residing on an area of the body that is infrequently observed visually. For example, melanomas located on difficult to observe areas (e.g., the bottom of a foot) are often more dangerous than melanomas located on easily observable body areas simply because they are less likely to be noticed early, and therefore, are often allowed to develop into more dangerous, serious melanomas. Accordingly, the L analysis data 230 generated by the mole analyzer 208 may be provided to the melanoma risk assessment generator 216 to be considered in generating the plurality of melanoma risk assessments 218. That is, the melanoma risk assessment generator 216 may additionally consider the L analysis data 230 (along with the ABC analysis data 212 and the D analysis data 214) in generating the plurality of melanoma risk assessments 218 for any particular mole.

Moreover, in one exemplary embodiment, the melanoma risk assessment generator 216 may obtain user gender information (not shown) for consideration in generating the plurality of melanoma risk assessments 218. The user gender information may be obtained in any number of suitable ways known to those having skill in the art. For example, in one embodiment, a user gender input field may be provided as part of one or more of the GUIs 222, 224, 226. In another embodiment, the user gender information may be obtained through a user gender input field (e.g., radio button allowing the user to select their gender as either male or female) implemented as a stand-alone GUI. Regardless of the manner in which user gender information is obtained, the user gender information may indicate whether the user of the computing system 200 is either male or female. For example, research indicates that for men, melanoma most often appears (a) on the upper body (e.g., between the shoulders and hips) or (b) on the head and neck. Conversely, research indicates that for women, melanoma most often appears on the lower legs. Accordingly, in this embodiment, the melanoma risk assessment generator 216 may also consider gender information (along with, or separate from, the L analysis data 230, the ABC analysis data 212, the D analysis data 214, etc.) in generating the plurality of melanoma risk assessments 218.

In another exemplary embodiment, the melanoma risk assessment generator 216 is further configured to provide an evolution risk assessment 246 for a particular mole. An evolution risk assessment 246 includes information describing how likely it is that a particular mole is melanoma given how the mole has evolved over time. In operation, the melanoma risk assessment generator 216 is configured to provide the evolution risk assessment 246 through the following process or a substantially similar process known to those having ordinary skill in the art.

In this embodiment, the mole detector 202 is further configured to obtain new mole image information 234. The new mole image information 234 includes one or more digital images of at least the particular mole for which melanoma risk assessment is sought. The new mole image information 234 is obtained after the mole image information 204 discussed previously. In this manner, the new mole image information 234 may be more “up-to-date” than the mole image information 204 and may be used to assess how the particular mole has changed over time. The mole detector 202 may detect the particular mole based on the new mole image information 234 in order to provide new particular mole image information 236.

Continuing with this exemplary embodiment, the mole analyzer 208 may be further configured to obtain new mole diameter information 238. The new mole diameter information 238 includes information describing a new estimated diameter of the particular mole. In this manner, the new mole diameter information 238 can inform the mole analyzer 208 whether the particular mole has grown over time. Accordingly, the mole analyzer 208 is also configured to analyze the new mole diameter information 238 to determine whether the new estimated diameter of the particular mole exceeds the predetermined threshold to provide new diameter (D) analysis data 242. Again, the predetermined threshold may be 6 mm as discussed previously, or any other suitable threshold for identifying whether a given mole exhibits symptoms of melanoma.

Regardless, the mole analyzer 208 is further configured to analyze the new particular mole image information 236 to make number of determinations concerning the particular mole. Specifically, the mole analyzer 208 is further configured to analyze the new particular mole image information 236 to determine (i) whether the particular mole is substantially asymmetrical, (ii) whether the border of the particular mole is substantially circular, and (iii) whether the particular mole comprises one or more substantially different colors to provide new asymmetry, border, and color (ABC) analysis data 240. These determinations may be performed substantially in line with the discussion on generating the ABC analysis data 212 described in detail above.

Further still, in this embodiment, the melanoma risk assessment generator 216 is configured to perform additional functions. Specifically, in this embodiment, the melanoma risk assessment generator 216 is further configured to generate a plurality of new melanoma risk assessments 244 for the particular mole based on at least the new ABC analysis data 240 and the new D analysis data 242. These new melanoma risk assessments 244 provide a more up-to-date report on the likelihood of the particular mole being melanoma then the melanoma risk assessments 218 and can take any of the forms previously discussed. For instance, the new melanoma risk assessments 244 may be provided on a per-ABCD factor basis, may include a new cumulative melanoma risk assessment (that is generated based on one or more of the new melanoma risk assessments 244), or any combination of these options.

In addition, the melanoma risk assessment generator 216 is configured to compare each respective new melanoma risk assessment of the plurality of new melanoma risk assessments 244 with a corresponding melanoma risk assessment of the plurality of melanoma risk assessments 218 to provide the evolution risk assessment 246 discussed above. For example, the melanoma risk assessments 218 associated with each of the ABCD factors might initially characterize a particular mole as being low-risk for melanoma (e.g., there is low-risk risk assessment reported as to a particular mole for each of the ABCD factors). However, a user might employ the computing device 200 to perform a new melanoma risk assessment, for example, six months after the initial melanoma risk assessment was performed. The new melanoma risk assessment could characterize the particular mole as now being a medium-risk for melanoma (e.g., there is a medium-risk assessment reported as to the particular mole for each of the ABCD factors). In this example, the melanoma risk assessment generator 216 would be operative to compare each initial risk-assessment with a corresponding new risk assessment to generate an evolution risk assessment 246. Continuing with the foregoing example, the evolution risk assessment 246 could indicate that the particular mole has a medium-risk of being melanoma because each of the respective ABCD factors have changed from low-risk to medium risk over the six month time frame.

Turning to FIG. 3, an exemplary illustration of the first GUI 222 is provided. As shown, the first GUI 222 includes an image capture field 302 and a mole selection marker 304. In one example, the first GUI 222 additionally includes an image capture button 306 enabled through one or more application programming interfaces (APIs) as discussed below. The image capture field 302 is depicted as being overlaid on top of mole image information 204, which comprises one or more digital images of one or more moles including a particular mole for which analysis is sought. The mole image information 204 is more commonly referred to as “camera preview display data.” For example, those having ordinary skill in the art will recognize that many computing devices (e.g., computing device 200) may include an integrated camera (e.g., camera 114) and a display device (e.g., display 116) capable of displaying the images being captured by the camera in substantially real-time. This display data is referred to as the mole image information 204 or camera preview display data herein. Although not shown in the Figures, the computing device 200 of the current disclosure may additionally include one or more suitable APIs configured to allow for the generation of the first GUI 222 over the mole image information 204 using techniques known in the art. In addition, the one or more APIs may allow for the components of the first GUI 222, such as the capture button 306, to capture one or more still images for storage remotely, or locally on the computing device 200 (e.g., in memory 106).

GUI 222 also includes a mole selection marker 304. The mole selection marker 304 includes display data identifying the particular mole for which analysis is sought. While the example illustrated in FIG. 3 depicts the mole selection marker 304 as a circular “dot,” it is contemplated that the mole selection marker 304 may take any shape desired (e.g., a cross, a star, a square, etc.). Furthermore, in one example, the mole selection marker 304 is a particular color such as florescent green, although any suitable color may be selected as desired. In this manner, the mole selection marker 304 may be clearly distinguished from the underlying camera preview display data.

In operation, a user may direct the camera (e.g., camera 114) of the computing device 200 at a mole on their body that they wish to receive a melanoma risk assessment for. The user may view the first GUI 222 including the mole image information 204 on a display (e.g., display 116) of the computing device 200. The user may then frame the particular mole for which analysis is sought within the image capture field 302 of the first GUI 222. The mole detector 202 of the computing device 200 is configured to detect one or more moles present within the image capture field 302 portion of the mole image information 204 by performing digital image processing. For example, in one embodiment, the mole detector 202 is configured to analyze pixel data associated with each of the pixels located within the image capture field 302 portion of the mole image information 204 to identify which pixels are representative of moles. Techniques for assessing pixel data to determine what the pixels represent are well known to those having ordinary skill in the art. In this manner, the mole detector 202 is configured to detect the particular mole from among one or more moles based on the mole image information 204.

When the user is satisfied that the mole selection marker 304 is overlaid on top of the image data representing the particular mole that they want analyzed (and within the image capture field 302), the user may cause an image to be captured (e.g., by pressing the capture button 306 on the first GUI 222 in an embodiment where the display includes touch-screen capabilities) thereby creating particular mole image information 206. The particular mole image information 206 includes, for example, a “snapshot” digital image of all of the content within the image capture field 302 at the time that the image was captured, including image data representing the particular mole for which melanoma risk assessment is sought. While the foregoing description only discussed one means of capturing image data, those having ordinary skill in the art will recognize that other suitable means for capturing the image data (e.g., a physical button on the computing device 200) may be equally employed.

Mole Detecting

In one example, the mole detecting functionality is provided as follows. An image is captured and a first “area of interest” is defined within the captured image (e.g., a geometric area corresponding to the center of the captured image). The captured image may be cropped around the area of interest (e.g., using cropping techniques known in the art) to produce a smaller image. This smaller image may then be converted into YC_{B}C_{R} color space. In one example, the C_{B} and C_{R} channels are discarded as unnecessary for performing the subsequent processing. A binary, square template (i.e., a “kernel”) may then be created such that the size of the kernel is less than the size of the cropped image. The kernel may comprise a planar region of bit value 1 surrounding a two-dimensional disc at the center of the kernel with a bit value of 0. The radius of the disc may be, in one example, approximately one-fourth (¼) of the width of the template (kernel). The template may be convoluted with the smaller image using techniques known in the art, such that a response matrix is created. The response matrix may be created using the following equation, where T is the template matrix, I is the smaller image, and R is the response matrix:

$$R ( x , y ) = \frac{{\sum }_{{x}^{′} , {y}^{′}} ( T ( {x}^{′} , {y}^{′} ) \cdot {I}^{′} ( x + {x}^{′} , y + {y}^{′} ) )}{\sqrt{{\sum }_{{x}^{′} , {y}^{′}} {T ( {x}^{′} , {y}^{′} )}^{2} \cdot {\sum }_{{x}^{′} , {y}^{′}} {I ( x + {x}^{′} , y + {y}^{′} )}^{2}}}$$

The response matrix may then be searched for its peak value. The location of the particular mole in the image corresponds to the location of the highest value in the response matrix, plus the distance from the edge of the template to the center of the disc in the template.

Examining Symmetry

In order to determine whether the particular mole is substantially asymmetrical, the mole analyzer 208 performs the following processing or substantially similar processing known to those having ordinary skill in the art. Once a point on a mole is identified as described above, a second area of interest may be defined from within the original image around the point on the mole. A normalization may be applied (using, for example, a Gaussian, Poison, or other distribution known to those having skill in the art) highlighting the contrast between substantially light and substantially dark regions within the second area of interest. Following the normalization, threshold processing may be applied to differentiate pixels representing skin from those representing the mole to be analyzed. In one example, the threshold processing may include normalizing the pixel data between 0 and 1 and treating those pixels having a value lower than 0.5 as corresponding to a mole, while treating those pixels having a value of 0.5 or greater as corresponding to skin. Of course, determinations concerning rounding pixel values and the use of a binary characterization scheme are matters of design choice and the threshold processing may be carried out in any number of suitable ways known to those having ordinary skill.

At this stage, another binary image (i.e., a “mask”) may be generated (e.g., by the mole analyzer 208, by another module within the computing device 200, or from a source remote from the computing device 200). This mask may be used by the mole analyzer 208 to identify the portion of the second area of interest image that is skin and the portion of the second area of interest image that is mole. For example, a value of 0 may be assigned to pixels within the image corresponding to the mole and a value of 1 may be assigned to pixels within the image corresponding to skin (or vice versa; i.e., any suitable classifying scheme may be suitably employed for this purpose).

The “mask” may then be used to locate the true center of the mole using center of mass techniques known to those having ordinary skill in the art. The mole (the mask) may then be folded over onto itself in the cardinal directions over the center of mass and the number of non-overlapping regions may be counted. The non-overlapping regions may be compared on a basis of percentage to the total area of the mole and scaled between 0 and 1 to achieve an asymmetry rating (i.e., to determine whether the particular mole under analysis is substantially asymmetrical). Specifically, in one example of this process, the mask may be rotated 180 degrees over its center of mass and placed on top of itself. At this point, the dark (mole) region of the mask will either overlap with a dark region of the image or overlap with a white (skin) region of the image. Where the dark region of the mask overlaps with the dark region of the image, this may be treated as a “hit.” Conversely, where the dark region of the mask overlaps with a white region of the image, this may be treated as a miss. The number of “hits” may then be divided by the number “hits” plus “misses” to determine a percentage of symmetry. This percentage of symmetry may then be used to provide a “symmetry” rating for any particular mole under analysis. In this manner, the mole analyzer 208 is configured to determine whether the particular mole is substantially asymmetrical.

Examining Border Irregularities

In order to determine whether a border of the particular mole is substantially circular, the mole analyzer 208 performs the following processing or substantially similar processing known to those having ordinary skill in the art. In one example, border points are defined as those points that lie on the “white” part of the mask (i.e., those pixels corresponding to a binary value of 1 in line with the convention described above) that are also adjacent to the dark part of the mask (i.e., those pixels corresponding to a binary value of 0 in line with the convention described above). The expected perimeter of the mole may be calculated in terms of pixels using the following equation, where A is the area of the mole as found in the mask and L is the expected number of border points.

L=2*π*sqrt(A/π)

Having calculated the expected perimeter of the mole, that expected perimeter may be compared to the number of “border points” found using the equation:

2−(number of border points)/L

Examining Color

The mask is once again used to determine what parts of the image correspond to the user's skin and which parts of the image correspond to the particular mole for which analysis is sought. Specifically, the color values that are determined to be part of the mole (see above) are converted to the HSL (hue, saturation, and lightness) color space using techniques well-known in the art. A hue average is calculated as a circular mean, and a standard deviation is computed accordingly. For example, a color rating may be calculated using the following equation where k is an experimental constant determined by calibrating images (e.g., k=⅙):

1−k*stdDev

In this manner, a color rating may be generated.

Turning now to FIG. 4, one example of the second GUI 224 is provided. As shown, the second GUI 224 includes an avatar of the human body 402 and display data representative of mole location information 404. While the example shown in FIG. 4 only illustrates an avatar 402 of the front of the human body, in one example, the second GUI 224 also includes an avatar of the back of a human body. In yet another example, avatars of the bottom of the human body (e.g., the bottom of the feet) and top of the body (e.g., top of the head) may also be provided.

In operation, a user may identify a particular location on the avatar 402 corresponding to a mole on their own body that they want analyzed for melanoma. For example, if a user has a mole on their right thigh that they want analyzed for melanoma, they can touch the right thigh of the avatar 402 (e.g., in an embodiment where the GUI 224 is implemented on a display with touch-screen capabilities). While the present example contemplates using touch-screen capabilities to identify the location of the mole to be analyzed, those having ordinary skill in the art will appreciate that other mechanisms for identifying mole location information 228 may be equally employed. Regardless, once a location on the avatar 402 has been identified, display data representative of the mole location information 404 may be generated as part of the GUI 224. In one example, the data representative of the mole location information 404 may be expressed in manner that indicates the likelihood of melanoma associated with the mole at that location (e.g., after melanoma risk assessments have been generated for that particular mole). For example, in one embodiment, the display data representative of the mole location information 404 may be color-coded, where different colors correspond to different levels of melanoma risk. Of course, other suitable schemes (e.g., using numbers or symbols instead of colors) may be equally employed.

By providing a mechanism for obtaining mole location information 228 through the second GUI 224, the mole location information 228 may be used to improve the accuracy of the melanoma risk assessments 218 generated by the melanoma risk assessment generator 216. For example, different portions of the avatar 402 may be supplied with different weights representing the likelihood of a particular mole located in that region being melanoma. This is based on an understanding that melanoma is more likely to occur in certain parts of the body than others. For example, in this embodiment, each of the legs of the avatar 402 may be given a certain weight, while the torso may be given a different weight.

Further still, a user of computing system 200 may track (and have analyzed) several different moles via the second GUI 224. That is, a user may indicate several locations on the avatar 402 corresponding to locations on their body where moles reside. Accordingly, display data representative of these locations may also be included as part of the GUI 224 (e.g., as a number of separate dots, although other suitable indicators may be equally employed). By providing display data representing a plurality of different moles on a single GUI (e.g., the second GUI 224), a user of the computing system 200 may track several different moles for melanoma risk. Moreover, in one embodiment, the mole location information 228 and the display data representative of the mole location information 404 may be saved in storage (e.g., memory 106) for subsequent processing. In this manner, a user may capture an image of a given mole (as identified by its location on the avatar 402) at a particular time and have it analyzed for melanoma risk in accordance with the techniques disclosed herein. Subsequently (e.g., three months later), the user may select the same mole on the avatar (e.g., by touching the display data on the avatar 402 representing that mole) for an updated analysis. The user may then capture a new, updated image of the mole in order to gain an updated analysis of the melanoma risk associated with that mole. Stated another way, once a user selects a location on the avatar 402 representing the location of a real-life mole, in one example, the second GUI 224 is configured to always include display data representing that mole, so that the mole may be tracked over time for melanoma risk.

FIG. 5 illustrates one example of the third GUI 226. As shown, the third GUI 226 includes a ruler 502 and a mole diameter input field 504. In operation, a user may hold the third GUI 226 next to the particular mole for which they desire a melanoma risk assessment in order to assess the diameter of the mole. The user may then provide the mole diameter information 210 to the computing device 200 via the third GUI 226 using the mole diameter input field 504 (e.g., by touching a mole diameter input button where the third GUI 226 is implemented on a display with touch-screen capabilities). While the illustrated embodiment shows three separate mole diameter input buttons (e.g., “Under 6 mm,” “About 6 mm,” and “Over 6 mm”), those having ordinary skill will recognize that the mole diameter input field 504 may suitably be implemented in any number of different ways. For example, the mole diameter input field 504 could also be implemented as a text box allowing the user to numerically enter the estimated diameter into the mole diameter input field 504 via a user input device such as keypad (e.g., via User I/O 110). The mole diameter information 210 input by the user may then be analyzed by the mole analyzer 208 to determine whether the estimated diameter of the particular mole exceeds a predetermined threshold (e.g., 6 mm), so as to provide the diameter (D) analysis data 214 as discussed above.

FIG. 6 illustrates one example of a fourth GUI 600. In this example, the fourth GUI 600 includes a cumulative melanoma risk assessment 602 and a plurality of melanoma risk assessments specific to each of the ABCDE factors 604. In the example shown, the cumulative melanoma risk assessment 602 includes display data indicating the likelihood of a particular mole being melanoma. In one embodiment, this likelihood may be determined based on separate melanoma risk assessments associated with one or more of the ABCDE factors 604. For example, if each of the discrete melanoma risk assessments associated with each of the ABCDE factors 604 indicate that the mole is unlikely to be melanoma, the cumulative melanoma risk assessment 602 could also indicate that the mole is unlikely to be melanoma. In another example, where even one melanoma risk assessment of the plurality of the melanoma risk assessments 604 indicates that there is an increased likelihood of a particular mole being melanoma, the cumulative melanoma risk assessment 602 may also indicate that increased likelihood.

In other examples, particular weighting may be applied to the melanoma risk assessments associated with each of the ABCDE factors 604 in order to arrive at the cumulative melanoma risk assessment 602. For instance, research might conclude that the evolution of a particular mole (i.e., the “E” factor or the “evolution risk assessment 246” described above) is the strongest indicator of whether the particular mole is melanoma. Accordingly, in this example, the cumulative melanoma risk assessment 602 may be generated based on a combination of the ABCDE-specific melanoma risk assessments 604, where the melanoma risk assessment associated with the “E” factor is given greater weight. Of course, the foregoing is merely exemplary in nature and those having ordinary skill in the art will appreciate that there are a variety of suitable ways for generating the cumulative melanoma risk assessment 602 in accordance with the instant disclosure.

Furthermore, while the example shown in FIG. 6 employs a color scheme for reporting the cumulative melanoma risk assessment 602 and the plurality of melanoma risk assessments 604 (e.g., where the color green indicates a low probability of melanoma, yellow indicates a moderate probability of melanoma, and red indicates a high probably of melanoma), those having ordinary skill will recognize that any suitable reporting scheme may be used. For example, consistent with the teachings of the instant disclosure, a numeric scale (e.g., a ten-point scale where “1” indicates a low probability of melanoma and “10” indicates a high probability of melanoma) could also be used to report the likelihood of a particular mole being melanoma. In yet another example, the cumulative melanoma risk assessment 602 and the plurality of melanoma risk assessments 604 may be reported using different schemes. For example, in this embodiment, the cumulative melanoma risk assessment 602 could be reported using a numeric scale while the plurality of melanoma risk assessments 604 are each reported using a color-coded scale. Other suitable reporting schemes (e.g., through the use of symbols) may be equally employed.

Furth still, the melanoma risk assessment associated with evolution (i.e., the “E” factor or the “evolution risk assessment 246”) may be generated in line with the discussion above. For example, in one embodiment, melanoma risk assessments associated with one or more of the ABCD factors from a given point in time may be compared against corresponding melanoma risk assessments associated with one or more of the ABCD factors from a later point in time for the same mole. For example, an initial melanoma risk assessment may indicate that the risk associated with the “D” factor for a particular mole is low because the particular mole's diameter is less than 6 mm. However, a subsequent melanoma risk assessment may indicate that the new risk associated with the “D” factor for the same particular mole is high because the particular mole's diameter has grown to greater than 6 mm since the initial assessment was performed. In this example, a “high-risk” melanoma risk assessment may be generated with regard to the “E” factor based upon a comparison of the initial melanoma risk assessment with regard to the “D” factor with the later-in-time melanoma risk assessment with regard to the “D” factor.

Of course, generating the melanoma risk assessment associated with the “E” factor for a particular mole is not limited to comparisons of the melanoma risk assessments associated with the diameter of the mole over time. Rather, the melanoma risk assessment associated with the “E” factor may be generated by comparing any of the ABCD melanoma risk assessments from a given time with corresponding ABCD melanoma risk assessments from a subsequent time. Further still, weighting techniques may be employed to influence the generation of the melanoma risk assessment associated with the “E” factor (i.e., generation of the evolution risk assessment 246). For example, research may conclude that a growing diameter is more indicative of melanoma than, for example, a change in the symmetry of the mole. Accordingly, in this example, a change in a mole's diameter may be weighted more heavily than a change in the mole's symmetry when generating the melanoma risk assessment associated with the “E” factor.

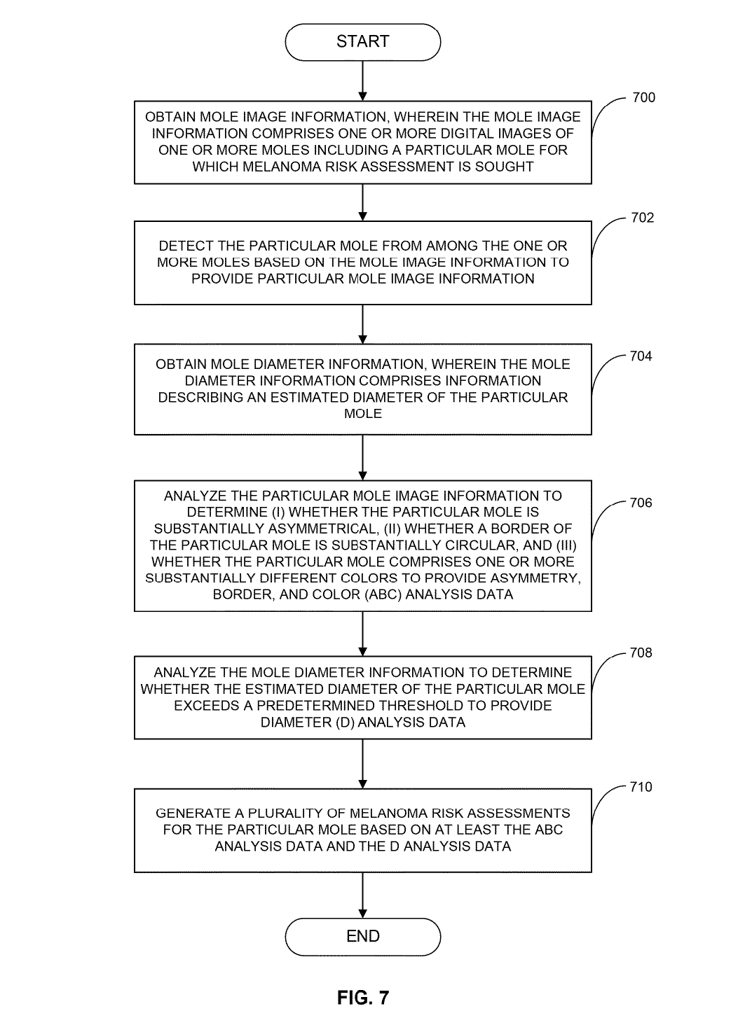

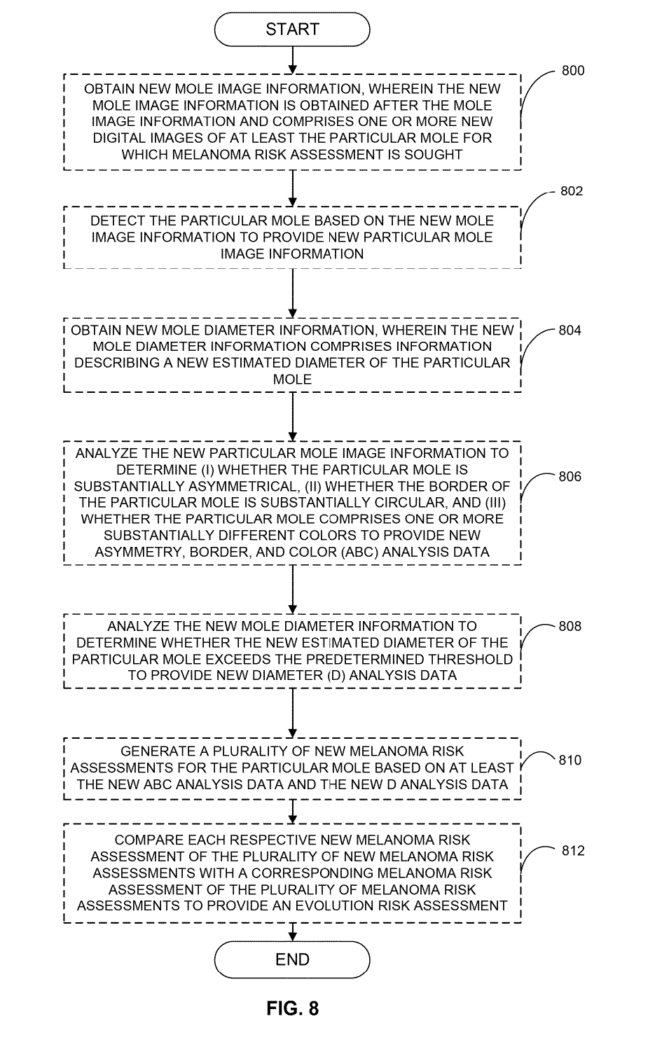

Referring now to FIG. 7 and FIG. 8, flow diagrams illustrating methods for generating melanoma risk assessments in accordance with one embodiment of the instant disclosure (FIG. 7) and generating an evolution risk assessment in accordance with one embodiment of the instant disclosure (FIG. 8) are provided. While the computing devices 100, 200 are two forms for implementing the processing described herein (including that illustrated in FIG. 7 and FIG. 8), those having ordinary skill in the art will appreciate that other, functionally equivalent techniques may be employed. Furthermore, as known in the art, some or all of the functionalities implemented via executable instructions may also be implemented using firmware and/or hardware devices such as supplication specific circuits (ASICs), programmable logic arrays, state machines, etc. Once again, those of ordinary skill in the art will appreciate the wide number of variations that may be used in this manner.

Beginning at step 700, mole image information may be obtained. Mole image information may include one or more digital images of one or more moles including a particular mole for which melanoma risk assessment is sought. At step 702, the particular mole may be detected from among the one or more moles based on the mole image information to provide particular mole image information. At step 704, mole diameter information may be obtained. Mole diameter information includes information describing an estimated diameter of the particular mole. At step 706, the particular mole image information may be analyzed. Specifically, the particular mole image information may be analyzed to determine (i) whether the particular mole is substantially asymmetrical, (ii) whether a border of the particular mole is substantially circular, and (iii) whether the particular mole comprises one or more substantially different colors to provide asymmetry, border, and color (ABC) analysis data. At step 708, the mole diameter information may be analyzed. In particular, the mole diameter information may be analyzed to determine whether the estimated diameter of the particular mole exceeds a predetermined threshold to provide diameter (D) analysis data. Finally, at step 710, a plurality of melanoma risk assessments may be generated for the particular mole based on at least the ABC analysis data and the D analysis data.

FIG. 8 illustrates a method for generating an evolution risk assessment for a particular mole in accordance with one embodiment. In one example, the steps illustrated in FIG. 8 may be performed after the steps 700-710 described above, although this is not required. Beginning at step 800, new mole image information is obtained. The new mole image information is one or more new digital images of a previously photographed mole (i.e., the particular mole for which melanoma risk assessment is sought). In this manner, the new mole image information is obtained after the mole image information described above with regard to step 700. At step 802, the particular mole for which melanoma risk assessment is sought is detected based on the new mole image information to provide new particular mole image information. At step 804, new mole diameter information is obtained. The new mole diameter information includes information describing a new estimated diameter of the particular mole.

At step 806, the new particular mole image information may be analyzed to determine (i) whether the particular mole is substantially asymmetrical, (ii) whether a border of the particular mole is substantially circular, and (iii) whether the particular mole comprises one or more substantially different colors to provide new asymmetry, border, and color (ABC) analysis data. At step 808, the new mole diameter information may be analyzed to determine whether the new estimated diameter of the particular mole exceeds a predetermined threshold to provide new diameter (D) analysis data. At step 810, a plurality of new melanoma risk assessments are generated for the particular mole based on at least the new ABC analysis data and the new D analysis data. Finally, at step 812, each respective new melanoma risk assessment of the plurality of new melanoma risk assessments is compared with a corresponding melanoma risk assessment of the plurality of melanoma risk assessments to provide an evolution risk assessment.

Certain embodiments of this technology are described above with reference to block and flow diagrams of computing devices and methods and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of this disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

In line with the above-discussion concerning computer program products, in one example embodiment, a computer program product is provided that generates a plurality of melanoma risk assessments. In this example embodiment, a computer program product embodied in a non-transitory computer-readable medium including an algorithm adapted to effectuate a method is provided. This method may include detecting a particular mole from among one or more moles based on mole image information to provide particular mole image information, wherein the mole image information comprises one or more digital images of one or more moles including the particular mole for which melanoma risk assessment is sought; analyzing the particular mole image information to determine (i) whether the particular mole is substantially asymmetrical, (ii) whether a border of the particular mole is substantially circular, and (iii) whether the particular mole comprises one or more substantially different colors to provide asymmetry, border, and color (ABC) analysis data; analyzing mole diameter information to determine whether an estimated diameter of the particular mole exceeds a predetermined threshold to provide diameter (D) analysis data, wherein the mole diameter information comprises information describing the estimated diameter of the particular mole; and generating a plurality of melanoma risk assessments for the particular mole based on at least the ABC analysis data and the D analysis data.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any devices or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method comprising:
obtaining, by a processing device, mole image information, wherein the mole image information comprises one or more digital images of one or more moles including a particular mole for which melanoma risk assessment is sought;
detecting, by the processing device, the particular mole from among the one or more moles based on the mole image information to provide particular mole image information;
obtaining, by the processing device, mole diameter information, wherein the mole diameter information comprises information describing an estimated diameter of the particular mole;
analyzing, by the processing device, the particular mole image information to determine (i) whether the particular mole is substantially asymmetrical, (ii) whether a border of the particular mole is substantially circular, and (iii) whether the particular mole comprises one or more substantially different colors to provide asymmetry, border, and color (ABC) analysis data;
analyzing, by the processing device, the mole diameter information to determine whether the estimated diameter of the particular mole exceeds a predetermined threshold to provide diameter (D) analysis data; and
generating, by the processing device, a plurality of melanoma risk assessments for the particular mole based on at least the ABC analysis data and the D analysis data.

2. The computer-implemented method of claim 1, wherein detecting the particular mole from among the one or more moles comprises:
generating, by the processing device, a first graphical user interface comprising an image capture field and a mole selection marker, wherein the mole selection marker comprises display data identifying the particular mole for which analysis is sought.

3. The computer-implemented method of claim 1, further comprising:
generating, by the processing device, a second graphical user interface comprising an avatar of a human body; and
obtaining, by the processing device, mole location information, wherein the mole location information comprises information identifying a location on the avatar corresponding to the particular mole for which analysis is sought.

4. The computer-implemented method of claim 3, further comprising:
analyzing, by the processing device, the mole location information to determine if the particular mole resides in a high-melanoma risk area to provide location (L) analysis data; and
wherein generating the plurality of melanoma risk assessments for the particular mole is also based on the L analysis data.

5. The computer-implemented method of claim 1, wherein obtaining the mole diameter information comprises:
generating, by the processing device, a third graphical user interface comprising a ruler and a mole diameter input field, wherein the mole diameter input field is configured to obtain the mole diameter information.

6. The computer-implemented method of claim 1, wherein generating the plurality of melanoma risk assessments for the particular mole comprises generating a separate melanoma risk assessment with regard to asymmetry, border, color, and diameter.

7. The computer-implemented method of claim 1, further comprising:
generating, by the processing device, a cumulative melanoma risk assessment for the particular mole, wherein the cumulative melanoma risk assessment is based on one or more of the plurality of melanoma risk assessments.

8. The computer-implemented method of claim 1, further comprising:
obtaining, by the processing device, new mole image information, wherein the new mole image information is obtained after the mole image information and comprises one or more new digital images of at least the particular mole for which melanoma risk assessment is sought;
detecting, by the processing device, the particular mole based on the new mole image information to provide new particular mole image information;
obtaining, by the processing device, new mole diameter information, wherein the new mole diameter information comprises information describing a new estimated diameter of the particular mole;
analyzing, by the processing device, the new particular mole image information to determine (i) whether the particular mole is substantially asymmetrical, (ii) whether the border of the particular mole is substantially circular, and (iii) whether the particular mole comprises one or more substantially different colors to provide new asymmetry, border, and color (ABC) analysis data;
analyzing, by the processing device, the new mole diameter information to determine whether the new estimated diameter of the particular mole exceeds the predetermined threshold to provide new diameter (D) analysis data;
generating, by the processing device, a plurality of new melanoma risk assessments for the particular mole based on at least the new ABC analysis data and the new D analysis data; and
comparing, by the processing device, each respective new melanoma risk assessment of the plurality of new melanoma risk assessments with a corresponding melanoma risk assessment of the plurality of melanoma risk assessments to provide an evolution risk assessment.

9. A computing device comprising:
a mole detector configured to:
obtain mole image information, wherein the mole image information comprises one or more digital images of one or more moles including a particular mole for which melanoma risk assessment is sought; and
detect the particular mole from among the one or more moles based on the mole image information to provide particular mole image information;
a mole analyzer operatively connected to the mole detector, the mole analyzer configured to:
obtain mole diameter information, wherein the mole diameter information comprises information describing an estimated diameter of the particular mole;
analyze the particular mole image information to determine (i) whether the particular mole is substantially asymmetrical, (ii) whether a border of the particular mole is substantially circular, and (iii) whether the particular mole comprises one or more substantially different colors to provide asymmetry, border, and color (ABC) analysis data; and
analyze the mole diameter information to determine whether the estimated diameter of the particular mole exceeds a predetermined threshold to provide diameter (D) analysis data; and
a melanoma risk assessment generator operatively connected to the mole analyzer, the melanoma risk assessment generator configured to generate a plurality of melanoma risk assessments for the particular mole based on at least the ABC analysis data and the D analysis data.

10. The computing device of claim 9, further comprising:
a graphical user interface generator configured to generate at least one of the following:
a first graphical user interface comprising an image capture field and a mole selection marker, wherein the mole selection marker comprises display data identifying the particular mole for which analysis is sought;
a second graphical user interface comprising an avatar of a human body; and
a third graphical user interface comprising a ruler and a mole diameter input field, wherein the mole diameter input field is configured to obtain the mole diameter information.

11. The computing device of claim 10, wherein the mole analyzer is further configured to:
obtain mole location information, wherein the mole location information comprises information identifying a location on the avatar corresponding to the particular mole for which analysis is sought; and
analyze the mole location information to determine if the particular mole resides in a high-melanoma risk area to provide location (L) analysis data.

12. The computing device of claim 11, wherein the melanoma risk assessment generator is further configured to:
generate the plurality of melanoma risk assessments for the particular mole also based on the L analysis data.

13. The computing device of claim 9, wherein the melanoma risk assessment generator is further configured to generate a separate melanoma risk assessment for the particular mole with regard to asymmetry, border, color, and diameter.

14. The computing device of claim 9, wherein the melanoma risk assessment generator is further configured to generate a cumulative melanoma risk assessment for the particular mole, wherein the cumulative melanoma risk assessment is based on one or more of the plurality of melanoma risk assessments.

15. The computing device of claim 9, wherein:
the mole detector is further configured to:
obtain new mole image information comprising one or more new digital images of at least the particular mole for which melanoma risk assessment is sought; and
detect the particular mole based on the mole image information to provide new particular mole image information;
the mole analyzer is further configured to:
obtain new mole diameter information, wherein the new mole diameter information comprises information describing a new estimated diameter of the particular mole;
analyze the new particular mole image information to determine (i) whether the particular mole is substantially asymmetrical, (ii) whether the border of the particular mole is substantially circular, and (iii) whether the particular mole comprises one or more substantially different colors to provide new asymmetry, border, and color (ABC) analysis data; and
analyze the new mole diameter information to determine whether the new estimated diameter of the particular mole exceeds the predetermined threshold to provide new diameter (D) analysis data; and
the melanoma risk assessment generator is further configured to:
generate a plurality of new melanoma risk assessments for the particular mole based on at least the new ABC analysis data and the new D analysis data; and
compare each respective new melanoma risk assessment of the plurality of new melanoma risk assessments with a corresponding melanoma risk assessment of the plurality of melanoma risk assessments to provide an evolution risk assessment.

16. A computer program product embodied in a non-transitory computer-readable medium, the computer program product comprising an algorithm adapted to effectuate a method comprising:
detecting a particular mole from among one or more moles based on mole image information to provide particular mole image information, wherein the mole image information comprises one or more digital images of one or more moles including the particular mole for which melanoma risk assessment is sought;
analyzing the particular mole image information to determine (i) whether the particular mole is substantially asymmetrical, (ii) whether a border of the particular mole is substantially circular, and (iii) whether the particular mole comprises one or more substantially different colors to provide asymmetry, border, and color (ABC) analysis data;
analyzing mole diameter information to determine whether an estimated diameter of the particular mole exceeds a predetermined threshold to provide diameter (D) analysis data, wherein the mole diameter information comprises information describing the estimated diameter of the particular mole; and
generating a plurality of melanoma risk assessments for the particular mole based on at least the ABC analysis data and the D analysis data.

17. The computer program product of claim 16, wherein the algorithm adapted to effectuate the method further comprises:
generating a first graphical user interface comprising an image capture field and a mole selection marker, wherein the mole selection marker comprises display data identifying the particular mole for which analysis is sought.

18. The computer program product of claim 16, wherein the algorithm adapted to effectuate the method further comprises:
generating a second graphical user interface comprising an avatar of the human body;
obtaining mole location information, wherein the mole location information comprises information identifying a location on the avatar corresponding to the particular mole for which analysis is sought;
analyzing the mole location information to determine if the particular mole resides in a high-melanoma risk area to provide location (L) analysis data; and
wherein generating the plurality of melanoma risk assessments for the particular mole is also based on the L analysis data.

19. The computer program product of claim 16, wherein the algorithm adapted to effectuate the method further comprises:
generating a cumulative melanoma risk assessment for the particular mole, wherein the cumulative melanoma risk assessment is based on one or more of the plurality of melanoma risk assessments.

20. The computer program product of claim 16, wherein the algorithm adapted to effectuate the method further comprises:
obtaining new mole image information, wherein the new mole image information is obtained after the mole image information and comprises one or more new digital images of at least the particular mole for which melanoma risk assessment is sought;
detecting the particular mole based on the new mole image information to provide new particular mole image information;
obtaining new mole diameter information, wherein the new mole diameter information comprises information describing a new estimated diameter of the particular mole;
analyzing the new particular mole image information to determine (i) whether the particular mole is substantially asymmetrical, (ii) whether the border of the particular mole is substantially circular, and (iii) whether the particular mole comprises one or more substantially different colors to provide new asymmetry, border, and color (ABC) analysis data;
analyzing the new mole diameter information to determine whether the new estimated diameter of the particular mole exceeds the predetermined threshold to provide new diameter (D) analysis data;
generating a plurality of new melanoma risk assessments for the particular mole based on at least the new ABC analysis data and the new D analysis data; and
comparing each respective new melanoma risk assessment of the plurality of new melanoma risk assessments with a corresponding melanoma risk assessment of the plurality of melanoma risk assessments to provide an evolution risk assessment.
